(19) United States
(12) Patent Application Publication
(10) Pub. No.: US 2008/0068696 A1
(43) Pub. Date: Mar. 20, 2008

(54) Light reflecting device, light reflecting apparatus, wave front curvature modulator, and optical scanning type display device

(75) Inventors: Yasuo Nishikawa, Nagoya (JP); Nobuaki Asai, Hashima-gun (JP)

Correspondence Address: OLIFF & BERRIDGE, PLC, P.O. BOX 320850, ALEXANDRIA, VA, 22320-4850, US

(73) Assignee: BROTHER KOGYO KABUSHIKI KAISHA, NAGOYA (JP)

(21) Appl. No.: 11/898,597

(22) Filed: Sep. 13, 2007

Related U.S. Application Data
(63) Continuation-in-part of application No. PCT/JP2006/305245, filed on Mar. 16, 2006.

(30) Foreign Application Priority Data
Mar. 17, 2005 (JP) 2005-076277

(51) Int. Cl. G02B 26/08

(52) U.S. Cl. 359/224

(57) ABSTRACT

A light reflecting device includes an elastic plate portion configured to be elastically deformable, the elastic plate portion having a first surface and a second surface that is an opposite surface of the first surface, a mirror formed on the first surface of the elastic plate portion, at least one supporting portion configured to support the elastic plate portion to form a recessed area at a side of the second surface, and at least one strain-generating element provided on the second surface in the recessed area to bend the elastic plate portion in response to deformation thereof.

### CROSS-REFERENCE TO RELATED APPLICATION

This is a Continuation-in-Part of International Application No. PCT/JP2006/305245 filed on Mar. 16, 2006, which claims priority from Japanese Patent Application No. 2005-076277 filed on Mar. 17, 2005. The entire disclosure of the prior applications is incorporated herein by reference.

### BACKGROUND

1. Technical Field

The following description relates to one or more light reflecting techniques to allow light reflected by a mirror surface to undisturbedly advance in a reflected direction.

2. Related Art

Conventionally, there is cited as a light reflecting element, for example, variable optical surface unit disclosed in Japanese Patent Provisional Publication No. HEI 7-306367. The variable optical surface unit includes a frame, resiliently deformable substrate provided to an inner circumferential portion of the frame, optical surface formed as a metal thin film on a surface of the substrate to reflect incident light, and strain-generating element provided on a back surface of the substrate.

According to the aforementioned optical surface unit, since the optical surface is provided to the inner circumferential portion of the frame, there might be caused a problem that the light reflected by the optical surface is blocked by the frame not to undisturbedly advance in a reflected direction depending on the reflected direction.

### SUMMARY

Aspects of the present invention are advantageous in that there can be provided one or more improved light reflecting techniques to allow light reflected by a mirror surface to undisturbedly advance in a reflected direction.

According to aspects of the present invention, there is provided a light reflecting device, which includes an elastic plate portion configured to be elastically deformable, the elastic plate portion having a first surface and a second surface that is an opposite surface of the first surface, a mirror formed on the first surface of the elastic plate portion, at least one supporting portion configured to support the elastic plate portion to form a recessed area at a side of the second surface, and at least one strain-generating element provided on the second surface in the recessed area to bend the elastic plate portion in response to deformation thereof.

According to the light reflecting device configured as above, the strain-generating element is provided on the opposite surface (second surface) of the surface (first surface) of the elastic plate portion on which the mirror is formed. Therefore, the light reflecting device has no component that interrupts advance of the light reflected by the mirror on a side of the first surface. Accordingly, the light reflected by the mirror can completely advance in a reflected direction without any interrupt.

According to another aspect of the present invention, there is provided a light reflecting apparatus, which includes a first light reflecting device and second light reflecting device, each of which includes, an elastic plate portion configured to be elastically deformable and extend along a predetermined direction to be defined as a longitudinal direction thereof, the elastic plate portion having a first surface and a second surface that is an opposite surface of the first surface, a mirror formed on the first surface of the elastic plate portion; at least one supporting portion configured to support the elastic plate portion to form a recessed area on the second surface at a side of the second surface, and at least one strain-generating element provided on the second surface in the recessed area to bend the elastic plate portion in response to deformation thereof, the at least one strain-generating element being arranged to extend along the longitudinal direction of the elastic plate portion, an optical system configured to converge incident light and make the converged light incident onto the mirror of the first light reflecting device, and a reflecting plate configured to reflect, toward the mirror of the second light reflecting device, the light reflected by the mirror of the first light reflecting device. The first and second light reflecting devices are arranged such that the longitudinal directions of the elastic plate portions thereof are perpendicular to one another and such that the mirrors thereof are parallel to one another without the mirrors overlapping one another in a direction perpendicular to the mirrors.

In some aspects of the present invention, there can be provided the light reflecting apparatus configured as above, to which the aforementioned light reflecting device is applied to in a preferred manner.

According to a further aspect of the present invention, there is provided a wave front curvature modulator, which includes at least one light reflecting device each of which includes an elastic plate portion configured to be elastically deformable, the elastic plate portion having a first surface and a second surface that is an opposite surface of the first surface, a mirror formed on the first surface of the elastic plate portion to reflect incident light, at least one supporting portion configured to support the elastic plate portion to form a recessed area at a side of the second surface, and at least one strain-generating element provided on the second surface in the recessed area to bend the elastic plate portion in response to deformation thereof. The wave front curvature modulator further includes a control unit configured to control a strain-generated direction in which the at least one strain-generating element is deformed. The at least one light reflecting device generates reflected light with a wave front curvature thereof being modulated by deforming the elastic plate portion in response to the deformation of the at least one strain-generating element in the strain-generated direction controlled by the control unit.

In some aspects of the present invention, there can be provided the wave front curvature modulator configured as above, to which the aforementioned light reflecting device is applied to in a preferred manner.

According to a further aspect of the present invention, there is provided an optical scanning type display device, which includes a light emitting unit configured to emit image light that includes image information, a scanning unit configured to two-dimensionally scan the image light with the wave front curvature modulated by the wave front curvature modulator, and a wave front curvature modulator located on an optical path of the image light between the light emitting unit and the scanning unit. The wave front curvature modulator includes at least one light reflecting device that includes an elastic plate portion configured to be elastically deformable, the elastic plate portion having a first surface and a second surface that is an opposite surface of the first surface, a mirror formed on the first surface of the elastic plate portion, at least one supporting portion configured to support the elastic plate portion to form a recessed area at a side of the second surface, and at least one strain-generating element provided on the second surface in the recessed area to bend the elastic plate portion in response to deformation thereof. The wave front curvature modulator further includes a control unit configured to control a strain-generated direction in which the at least one strain-generating element is deformed. The at least one light reflecting device reflects the image light emitted by the light emitting unit to be incident to the scanning unit with the wave front curvature of the image light being modulated by deforming the elastic plate portion in response to the deformation of the at least one strain-generating element in the strain-generated direction controlled by the control unit.

In some aspects of the present invention, there can be provided the optical scanning type display device configured as above, to which the aforementioned wave front curvature modulator, provided with the aforementioned light reflecting device, is applied in a preferred manner.

### BRIEF DESCRIPTION OF THE ACCOMPANYING DRAWINGS

FIG. 1 is a perspective view of a light reflecting device in a first embodiment according to one or more aspects of the present invention.

FIG. 2 is a cross-sectional view of the light reflecting device along a line II-II shown in FIG. 1 according to one or more aspects of the present invention.

FIG. 3 schematically shows an elevational view of a light reflecting device in a second embodiment according to one or more aspects of the present invention.

FIG. 4 schematically shows a cross-sectional view of a light reflecting device in a third embodiment according to aspects of the present invention.

FIG. 5 schematically shows a cross-sectional view of a light reflecting device in a fourth embodiment according to aspects of the present invention.

FIG. 6 schematically shows a cross-sectional view of a wave front curvature modulator in a fifth embodiment according to one or more aspects of the present invention.

FIG. 7 schematically shows a top view of the wave front curvature modulator in the fifth embodiment according to one or more aspects of the present invention.

FIG. 8 schematically shows a cross-sectional view of a wave front curvature modulator in a sixth embodiment according to one or more aspects of the present invention.

FIG. 9 schematically shows a top view of a light reflecting element provided for the wave front curvature modulator in the sixth embodiment according to one or more aspects of the present invention.

FIG. 10 schematically shows a cross-sectional view of a wave front curvature modulator in a seventh embodiment according to one or more aspects of the present invention.

FIG. 11 schematically shows a cross-sectional view of a wave front curvature modulator in an eighth embodiment according to one or more aspects of the present invention.

FIG. 12 schematically shows a top view of a light reflecting element provided for the wave front curvature modulator in the eighth embodiment according to one or more aspects of the present invention.

FIG. 13 schematically shows a cross-sectional view of a wave front curvature modulator in a ninth embodiment according to one or more aspects of the present invention.

FIG. 14 schematically shows a top view of a light reflecting element provided for the wave front curvature modulator in the ninth embodiment according to one or more aspects of the present invention.

FIG. 15 schematically shows a cross-sectional view of a wave front curvature modulator in a tenth embodiment according to one or more aspects of the present invention.

FIG. 16 is a top view schematically showing an arrangement of light reflecting elements provided for the wave front curvature modulator in the tenth embodiment according to one or more aspects of the present invention.

FIG. 17 schematically shows an entire configuration of a retina scanning type display device in an eleventh embodiment according to one or more aspects of the present invention.

### DETAILED DESCRIPTION

Hereinafter, embodiments according to aspects of the present invention will be described with reference to the accompanying drawings.

### First Embodiment

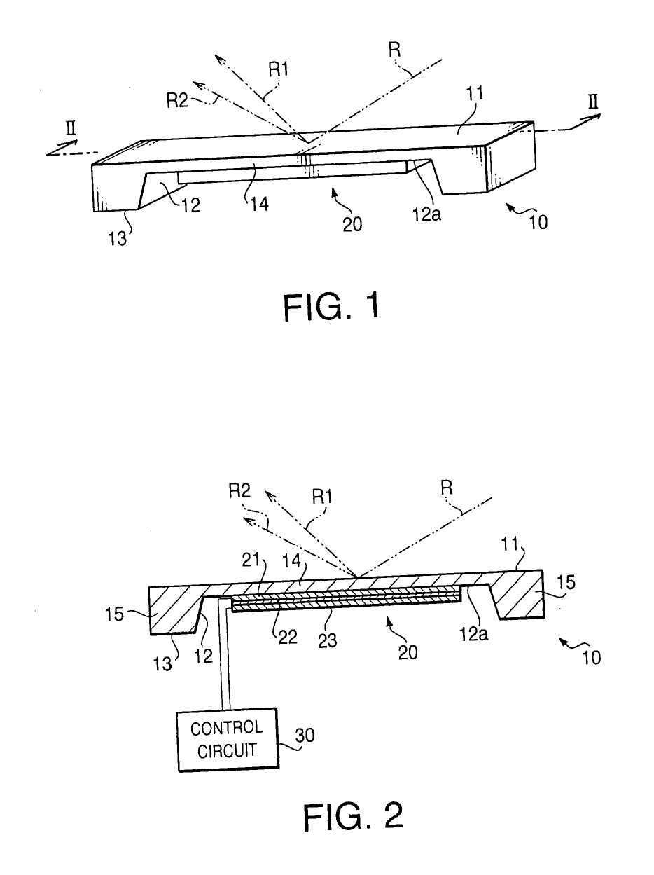

FIG. 1 is a perspective view of a light reflecting device in a first embodiment according to aspects of the present invention. FIG. 2 is a cross-sectional view of the light reflecting device along a line II-II shown in FIG. 1. The light reflecting device of the first embodiment is employed, for example, by a retina scanning type display device or a bar-cord reader. Specifically, in the retina scanning type display device, for example, the light reflecting device is provided between a front optical system including at least a light source and a light scanning system to control a reflected direction in which image light emitted from the front optical system is directed to the light scanning system.

As shown in FIGS. 1 and 2, the light reflecting device is provided with a substrate 10 and a long-plate-shaped strain-generating element 20. The substrate 10 is made from a silicon substrate and provided with a surface 11 formed as a polished surface. In addition, the substrate 10 is provided with a recess portion 12, which is formed by etching from a back surface side of the substrate 10. It is noted that a light reflecting element is configured with the substrate 10 and strain-generating element 20.

The substrate 10 includes a deformable thin plate elastic portion 14, which is formed between the surface 11 and a bottom surface 12a of the recess portion 12. Thereby, the substrate 10 is configured substantially U-shaped with the thin plate elastic portion 14 as an upper plate portion and a pair of side plate portions 15 (supporting plate portions 15). It is noted that a surface of the thin plate elastic portion 14 is configured with a part of the surface of the substrate 10. Further, the back surface 13 of the substrate 10 is attached to a fixed member when using the light reflecting device.

The strain-generating element 20 is provided on the bottom surface 12a in the recess portion 12 of the substrate 10 with a longitudinal direction of the strain-generating element 20 being arranged along a longitudinal direction of the bottom surface 12a. The strain-generating element 20 is, as shown in FIG. 2, formed from a piezoelectric element and configured with an electrode 21, piezoelectric substance 22, and an electrode 23.

The electrode 21 is formed as a film of electrode material on the bottom surface 12a of the recess portion 12 along the longitudinal direction thereof. The piezoelectric substance 22 is formed as a film of piezoelectric material on the electrode 21 along a longitudinal direction thereof. In addition, the electrode 23 is formed with the electrode material on the piezoelectric substance 22 along a longitudinal direction thereof to face the electrode 21 via the piezoelectric substance 22.

In the strain-generating element 20 thus configured, when a control voltage is applied to the piezoelectric substance 22 from a control circuit via both of the first and electrodes 21 and 23, the piezoelectric substance 22 is distorted to elongate or contract in a longitudinal direction thereof along a surface of the thin plate elastic portion 14.

When the piezoelectric substance 22 is distorted to elongate in the longitudinal direction thereof, the thin plate elastic portion 14 of the substrate 10 is bent so as to bulge toward a side of the recess portion 12. Meanwhile, when the piezoelectric substance 22 is distorted to contract in the longitudinal direction thereof, the thin plate elastic portion 14 of the substrate 10 is bent so as to bulge toward an opposite side of the recess portion 12.

Further, the light reflecting device is, as shown in FIG. 2, provided with the aforementioned control circuit 30. The control circuit 30 generates the control voltage to be applied between both the first and electrodes 21 and 23 of the strain-generating element 20. Thereby, the reflected direction of the image light that is incident onto the thin plate elastic portion 14 can be controlled to vary based on a deformation level of the thin plate elastic portion 14 depending on the control voltage from the control circuit 30.

Furthermore, in the light reflecting device of the first embodiment thus configured, when the control circuit generates the control voltage, the control voltage is applied between both of the first and electrodes 21 and 23 of the strain-generating element 20.

Then, when the piezoelectric substance 22 of the strain-generating element 20 is distorted to elongate in the longitudinal direction thereof depending on the applied control voltage, the thin plate elastic portion 14 of the substrate 10 is bent so as to bulge toward the side of the recess portion 12 in response to the elongation of the piezoelectric substrate 22.

In such a stage, when the image light, emitted from the front optical system in the aforementioned retina scanning type display device, is incident onto the surface of the thin plate elastic portion 14 of the substrate 10 in the light reflecting device as indicated by an arrow R in FIGS. 1 and 2, the incident image light is reflected in a direction indicated by an arrow R1 in FIGS. 1 and 2.

Meanwhile, when the piezoelectric substance 22 of the strain-generating element 20 is distorted to contract in the longitudinal direction thereof depending on the applied control voltage, the thin plate elastic portion 14 of the substrate 10 is bent so as to bulge toward the opposite side of the recess portion 12 in response to the contraction of the piezoelectric substrate 22.

In such a stage, when the image light, emitted from the front optical system in the aforementioned retina scanning type display device, is incident onto the surface of the thin plate elastic portion 14 of the substrate 10 in the light reflecting device as indicated by the arrow R in FIGS. 1 and 2, the incident image light is reflected in a direction indicated by an arrow R2 in FIGS. 1 and 2.

It is noted that an angle composed of an incident angle and a reflection angle of the image light, which varies depending on the bending deformation of the thin plate elastic portion 12 as described above, is larger when the image light is reflected in the reflected direction indicated by the arrow R2 than when the image light is reflected in the reflected direction indicated by the arrow R1. Such characteristics can be used for the light scanning device.

In addition, when the thin plate elastic portion 14 is bent as described above, the thin plate elastic portion 14 can easily be deformed, since the thin plate elastic portion 14 is free at both ends thereof in a width direction of the substrate 10.

Further, the substrate 10 has no component that interrupts advance of the reflected image light on a side of the surface 11. Accordingly, the image light reflected by the thin plate elastic portion 14 completely advances in the direction indicated by the arrow R1 or R2 without any interrupt, and is certainly emitted from the light reflecting device.

Further, as described above, the substrate 10 has no component that interrupts the advance of the reflected image light on the side of the surface 11. Hence, the image light reflected by the surface of the thin plate elastic portion 14 can be scanned over a wide angle range.

In addition, the strain-generating element 20 is, as described above, provided in the recess portion 12 formed from the back surface 13 of the substrate 10. Therefore, it is possible to prevent a problem that there might be required a more complicated manufacturing process for the light reflecting device since the strain-generating element 20 has to be arranged out of a reflecting area of the image light in the case where the strain-generating element 20 is provided on the side of the surface 11 of the substrate 10. Consequently, a generative force of the strain-generating element 20 can be enhanced, since it is possible to increase degrees of freedom for arranging the strain-generating element 20 on the substrate 10 and to widen an area on the substrate 10 in which the strain-generating element 20 can be arranged.

In addition, the surface 11 of the substrate 10, that is, the surface of the thin-plate elastic portion 14 is formed as a polished surface as described above. This is because the substrate 10 is formed from a silicon wafer that has a polished surface. Since the polished surface has very small surface roughness, it can serve as a mirror surface as it is.

Therefore, by using the polished surface as a mirror surface as it is, it is possible to prevent reduction of light intensity on the mirror surface.

Consequently, the light reflecting device can control the reflected direction of the image light so as to accurately respond to the deformation level of the thin plate elastic portion 14 caused by the strain-generating element 20, sufficiently maintaining the intensity of the image light.

Further, as described above, since the surface 11 of the substrate 10 formed as the polished surface is used as the mirror surface, an additional mirror surface member is not required to be provided on the surface of the thin plate elastic portion 14 to form the mirror surface.

Additionally, as mentioned above, the bottom surface 12a of the recess portion 12 of the substrate 10, on which the strain-generating element 20 is provided, is formed by the etching. Hence, it is easily attained to enlarge the surface roughness on the bottom surface 12a of the recess portion 12.

For this reason, the electrode 21 of the strain-generating element 20 can more firmly be attached on the bottom surface 12a. Consequently, preferred adhesion between the substrate 10 and the strain-generating element 20 can be attained. It makes it possible to efficiently convey the generative force of the strain-generating element 20 to the thin plate elastic portion.

### Second Embodiment

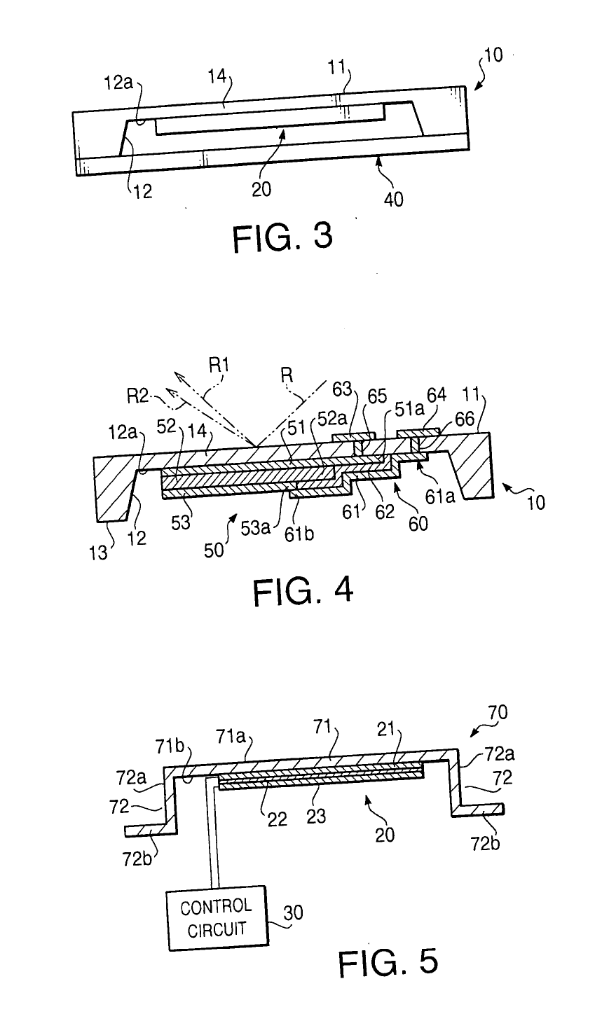

FIG. 3 shows a substantial part of a light reflecting device in a second embodiment according to aspects of the present invention. In the second embodiment, a supporting plate 40 is additionally employed in the aforementioned configuration of the light reflecting device in the first embodiment.

As shown in FIG. 3, the supporting plate 40 is fixed to the substrate 10 described in the first embodiment from the side of the back surface 13, and serves as a portion for attaching the light reflecting device to an appropriate fixed member. The other constitutions are the same as the first embodiment.

According to the light reflecting device thus configured in the second embodiment, the strain-generating element 20 is provided within the recess portion 12 of the substrate 10, and does not protrude outward from the back surface 13 of the substrate 10. Therefore, the supporting plate 40 does not get in the way when being fixed to the substrate 10 from the side of the back surface 13 as described above. Hence, the supporting plate 40 can directly be fixed to the substrate 10 from the side of the back surface 13 without using any additional member.

Consequently, by employing only the supporting plate 40, it is possible to easily attach the light reflecting device 40 to an appropriate fixed member. In addition, when the back surface 13 of the light reflecting device is configured as a polished surface, the supporting plate 40 can more firmly be fixed to the light reflecting device by using a polished surface for a surface of the supporting plate.

Further, as described above, the strain-generating element 20 is arranged within the recess portion 12, and the supporting plate 40 is fixed to the substrate 10 from the side of the back surface 13. Thereby, the strain-generating element 20 can certainly be protected by the supporting plate 40 from the back surface side of the substrate 10. Additionally, the same effects as the first embodiment can also be expected in the second embodiment.

### Third Embodiment

FIG. 4 shows a substantial part of a light reflecting device in a third embodiment according to aspects of the present invention. In the third embodiment, the light reflecting device is configured with a strain-generating element 50 as substitute for the strain-generating element 20 in the first embodiment.

The strain-generating element 50 is provided on the bottom surface 12a in the recess portion 12 of the substrate 10 such that a longitudinal direction of the strain-generating element 50 is arranged along a longitudinal direction of the bottom surface 12a. The strain-generating element 50 is provided with a piezoelectric element in the same manner as the stain-generating element 20. Further, as shown in FIG. 4, the strain-generating element 50 is configured with an electrode 51, a piezoelectric substance 52 shorter than the electrode 51, and an electrode 53 shorter than the piezoelectric substance 52.

The electrode 51 is formed as an electrode material film on the bottom surface 12a of the recess portion 12. The piezoelectric substance 52 is formed as a piezoelectric material film on the electrode 51 from a left end of the electrode 51 in FIG. 4. Since the electrode 51 is longer than the piezoelectric substance 52 as described above, the electrode 51 is, as shown in FIG. 4, extended to protrude rightward, at a right end portion 51a thereof, from a right end portion 52a of the piezoelectric substance 52.

In addition, as shown in FIG. 4, the electrode 53 is formed as an electrode material film along the piezoelectric substance 52 from a left end of the piezoelectric substance 52 in FIG. 4. Since the piezoelectric substance 52 is longer than the electrode 53 as described above, the piezoelectric substance 52 is, as shown in FIG. 4, extended to protrude rightward, at the right end portion 52a thereof, from a right end portion 53a of the electrode 53.

In addition, as shown in FIG. 4, the light reflecting device is provided with a connection circuit 60, which plays a role of connecting the strain-generating element 50 to the control circuit 30 in the first embodiment. The connection circuit 60 includes a lead 61 formed stair-shaped from conductive material. One side end portion 61a of the lead 61 is, as shown in FIG. 4, firmly adhered to a portion of the bottom surface 12a of the recess portion 12 of the substrate 10 at a right side of the electrode 51 in FIG. 4. Further, the other side end portion 61b of the lead 61 is connected to the right end portion 53a of the electrode 53.

Furthermore, the connection circuit 60 includes an insulating layer 62, which is formed stair-shaped from electrical insulating material. The insulating layer 62 is provided between a portion other than both of the side end portions 61a and 61b and each of the right end portion 51a of the electrode 51, the right end portion 52a of the piezoelectric substance 52, and the right end portion 53a of the electrode 53. Thereby, the insulating layer 62 plays a role of electrically isolating the electrode 53 from the electrode 51.

In addition, the connection circuit 60 includes both pads 63 and 64. The pad 63 is formed as a conductive material film in a position corresponding to the right end portion 51a of the electrode 51 on the surface of the thin plate elastic portion 14 of the substrate 10. Further, the pad 63 is electrically connected with the right end portion 51a of the electrode 51 via a through hole 65 formed in the thin plate elastic portion 14.

Meanwhile, the pad 64 is formed as a conductive material film in a position corresponding to the side end portion 61a of the lead 61 on the surface of the thin plate elastic portion 14 of the substrate 10. Further, the pad 64 is electrically connected with the right end portion 61a of the lead 51 via a through hole 66 formed in the thin plate elastic portion 14. The other constitutions of the light reflecting device in the third embodiment are the same as the first embodiment.

In the light reflecting device thus configured in the third embodiment, the connection circuit 60 includes the lead 61, both of the pads 63 and 64, and both of the through holes 65 and 66 that are provided as a whole at the right end portion side of each of the thin plate elastic portion 14 of the substrate 10 and the strain-generating element 50 so as to connect both of the electrodes 51 and 53 with the control circuit 30.

For this reason, the connection circuit 60 allows an integrated compact configuration of a circuit that connects the strain-generating element 50 with the control circuit 30 in the light reflecting device.

Further, in the third embodiment, in the same manner as the first embodiment, when the control circuit 30 generates a control voltage, the control voltage is applied between both of the pads 63 and 64 of the strain-generating element 50.

Then, the control voltage applied between both of the pads 63 and 64 is applied between both of the electrodes via both of the through holes 65 and 66 and the lead 61.

Thereafter, when the piezoelectric substance 52 of the strain-generating element 50 is distorted to elongate in the longitudinal direction thereof depending on the applied control voltage, the thin plate elastic portion 14 of the substrate 10 is bent to bulge toward the side of the recess portion 12 in response to the elongation of the thin plate elastic portion 14.

Meanwhile, when the piezoelectric substance 52 of the strain-generating element 50 is distorted to contract in the longitudinal direction thereof depending on the applied control voltage, the thin plate elastic portion 14 of the substrate 10 is bent to bulge toward the opposite side of the recess portion 12 in response to the contraction of the thin plate elastic portion 14.

In a state where the thin plate elastic portion 14 is bent to bulge toward the side or opposite side of the recess portion 12, when the image light emitted by a light source of the aforementioned retina scanning type display device is incident onto the thin plate elastic portion 14 of the substrate 10 in the light reflecting device as indicated by an arrow R in FIG. 4, the incident image light is reflected in a direction indicated by an arrow R1 or R2 in FIG. 4.

Thereby, the same effects as the first embodiment can be attained by the aforementioned compact configuration of the connection circuit 60 in the third embodiment.

### Fourth Embodiment

FIG. 5 shows a substantial part of a light reflecting device in a fourth embodiment according to aspects of the present invention. In the fourth embodiment, the light reflecting device is configured with a substrate 70 as substitute for the substrate 10 in the first embodiment.

The substrate 70 is integrally formed from a stainless steel sheet to have a cross-section as shown in FIG. 5. The substrate 70 is configured with a thin plate elastic portion 71 and both leg portions that extend as a crank toward a side of a back surface 71b of the thin plate elastic portion 71 from both ends of the thin plate elastic portion 71 to be directed in mutually reverse directions.

The thin plate elastic portion 71 of the substrate 70 has a surface 71a formed as a polished surface. Each of the leg portions 72 is formed as a crank with a first part 72a extending in an L-shape from each of the end portions of the thin plate elastic portion 71 and a second part 72b extending outward in an L-shape from the first part 72a.

It is noted that, in the fourth embodiment, the substrate 70 is supported with the second part 72b of each of the legs 72 being attached to an appropriate fixed member when using the light reflecting device.

Further, in the fourth embodiment, the strain-generating element 20 in the first embodiment is provided on the thin plate elastic portion 71 of the substrate 70 as substitute for the thin plate elastic portion 14 of the substrate 10.

The electrode 21 of the strain-generating element 20 is firmly attached on the back surface 71 of the thin plate elastic portion 71 of the substrate 70 to extend from one of both of the legs 72 to the other.

It is noted that the thin plate elastic portion 71, formed from conductive stainless steel, may be employed as an electrode without forming the electrode 21. Further, in the fourth embodiment, when the light reflecting device is used with the substrate 70 being attached to a conductive fixed member, an insulating film (not shown) is desired to be formed between the electrode 21 and the back surface 71b of the thin plate elastic portion 70. It makes it possible to expand a range of options of the fixed member to which the light reflecting device is to be attached. The other constitutions are the same as the first embodiment.

According to the light reflecting device thus configured in the fourth embodiment, in the same manner as the first embodiment, when the control circuit 30 applies a control voltage between both of the electrodes 21 and 23 of the strain-generating element 20, the piezoelectric substance 22 of the strain-generating element 20 is distorted to elongate or contract in a longitudinal direction thereof depending on the applied control voltage.

Hence, the thin plate elastic portion 71 of the substrate 70 is bent so as to bulge toward a side or an opposite side of an area between both of the legs 72 in response to the elongation or contraction of the piezoelectric substance 22.

Each of the first parts 72a of the substrate 70, which is formed from a stainless steel sheet, serves as a spring between the thin plate elastic portion 71 and each of the second parts 72b.

Therefore, the aforementioned curvature deformation of the thin plate elastic portion 71 is smoothly achieved by the spring functions of the first parts 72a.

Consequently, the reflected direction of the image light incident onto the surface 71a of the thin plate elastic portion 71 can smoothly and certainly be controlled. Additionally, the same effects as the first embodiment can also be attained in the fourth embodiment.

Further, in the fourth embodiment, when the supporting plate 40 as described in the second embodiment is provided over one of the second parts 72b to the other so as to face the strain-generating element 20, the same effects as the second embodiment can also be expected in the fourth embodiment.

### Fifth Embodiment

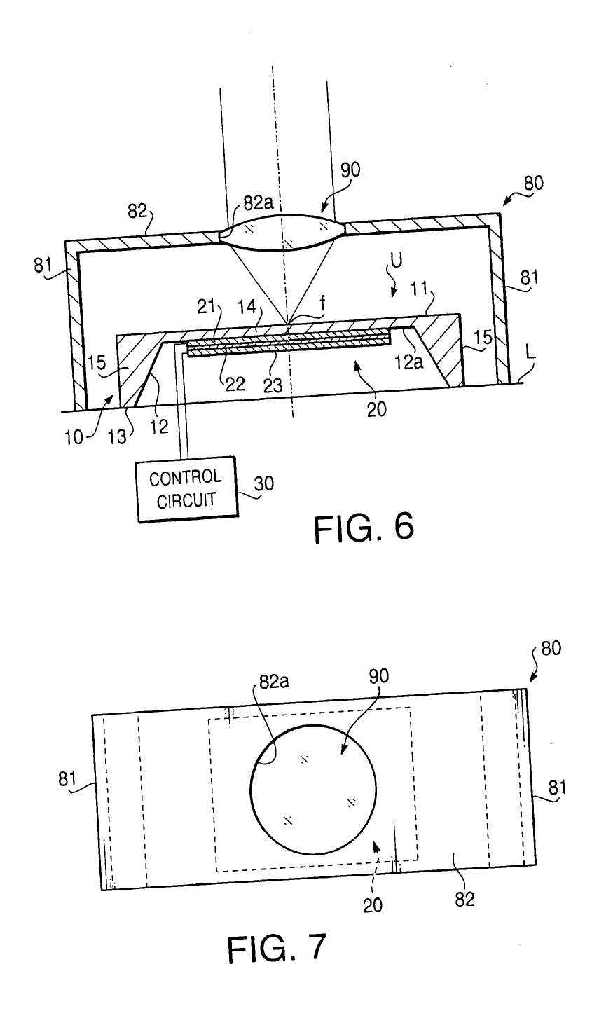

FIGS. 6 and 7 show an example of a wave front curvature modulator in a fifth embodiment to which the present invention is applied. The wave front curvature modulator is configured with the light reflecting device (hereinafter, referred to as a light reflecting device U) in the first embodiment, a U-shaped supporting member 80, and a convex lens 90.

As shown in FIGS. 6 and 7, the supporting member 80 is configured in a shape of a U character with both side plate portions 81 and an upper plate portion 82, and arranged on an installation surface L so as to cover the light reflecting device U.

The upper plate portion 82 is provided with an opening 82a, which is formed such that a center thereof is located in a position that corresponds to a center in a longitudinal direction of the thin plate elastic portion 14.

The convex lens 90 is concentrically fixed in the opening 82a of the supporting member 80. When the thin plate elastic portion 14 of the substrate 10 is not distorted, an image side focal point f (see FIG. 6) of the convex lens 90 is adopted to be located in a center of a mirror surface of the thin plate elastic portion 14. The other constitutions are the same as the first embodiment.

In the wave front curvature modulator thus configured in the fifth embodiment, when an optical system (not shown) emits collimated light along an optical axis thereof toward the convex lens 90, the collimated light is converged by the convex lens 90 and incident onto the center of the mirror surface of the thin plate elastic portion 14.

At this time, when the thin plate elastic portion 14 is not deformed, the collimated light is converged on the mirror surface of the thin plate elastic portion 14 since the image side focal point f of the convex lens 90 is adopted to be located in the center of the mirror surface as described above. Accordingly, the light thus converged is reflected on the center of the mirror surface of the thin plate elastic portion 14, and passes through the convex lens 90 to be collimated. The collimated light is then emitted in a reverse direction of the direction in which the incident collimated light advances.

In such a state, when the thin plate elastic portion 14 of the substrate 10 is bent to bulge toward the side of the recess portion 12 as described in the first embodiment, the light converged by the convex lens 90 is focused in the image side focal point f located above the center of the mirror surface of the thin plate elastic portion 14. Thereafter, the light is, as diverging light, incident onto the center of the mirror surface, and then reflected thereon.

Accordingly, the light reflected in this manner is converged by the convex lens 90, and advances toward the aforementioned optical system. At this time, the light, reflected on the center of the mirror surface of the thin plate elastic portion 14, is incident onto the aforementioned optical system as converged light that is not light with a plane wave front but light with a wave front curvature.

Meanwhile, when the thin plate elastic portion 14 of the substrate 10 is bent to bulge toward the opposite side of the recess portion 12 as described in the first embodiment, the light converged by the convex lens 90 is incident onto the center of the mirror surface of the thin plate elastic portion 14 above the image side focal point f located above. Thereafter, the light is reflected on the center of the mirror surface.

Accordingly, the light reflected in this manner advances toward the aforementioned optical system as diverging light after passing through the convex lens 90. In other words, the light, reflected on the center of the mirror surface of the thin plate elastic portion 14, advances toward the optical system as diverging light that is not light with a plane wave front but light with a wave front curvature.

As described above, in the fifth embodiment, the light converged by the convex lens 90 is focused above or under the center of the mirror surface of the thin plate elastic portion 14 depending on displacement of the thin plate elastic portion 14 toward the side or the opposite side of the recess portion 12.

Thereby, the wave front curvature of the light emitted from the convex lens 90 after being reflected on the center of the mirror surface of the thin plate elastic portion 14 can be modulated depending on the displacement of the thin plate elastic portion 14. The other effects in the fifth embodiment are the same as the first embodiment.

### Sixth Embodiment

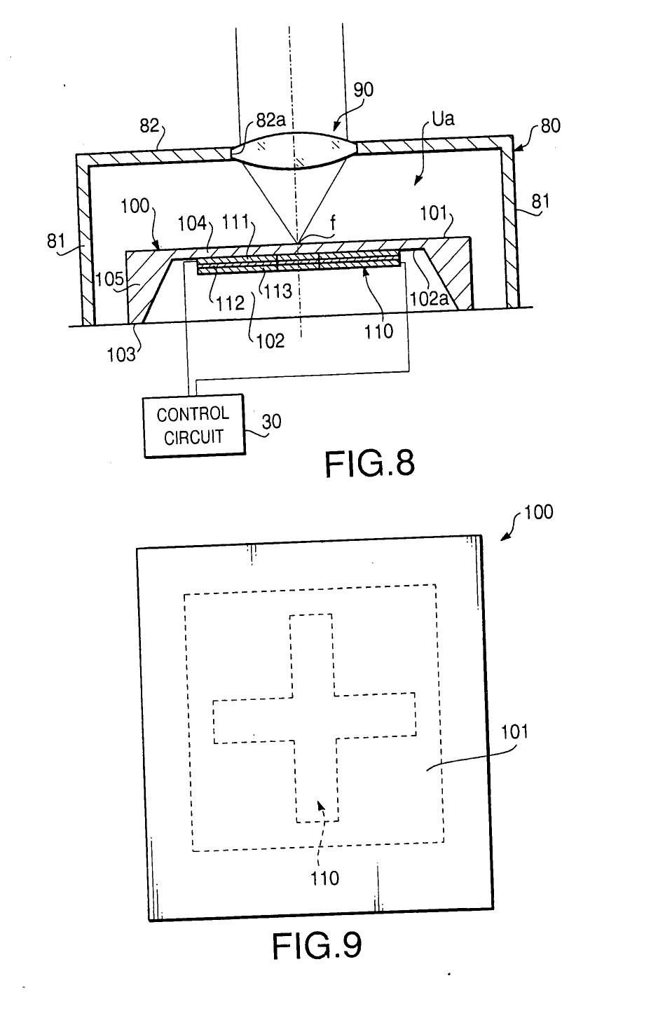

FIGS. 8 and 9 show a substantial part of a wave front curvature modulator in a sixth embodiment according to aspects of the present invention. In the sixth embodiment, there is shown another example of a wave front curvature modulator to which the present invention is applied. The wave front curvature modulator of the sixth embodiment is configured with a light reflecting device Ua as substitute for the light reflecting device U in the wave front curvature modulator of the fifth embodiment.

In the light reflecting device Ua, there is employed a configuration in which a substrate 100 and a cross-shaped strain-generating element 110 are provided instead of the substrate 10 and strain-generating device 20, respectively.

The substrate 100 is made of a silicon substrate in the same manner as the substrate 10. A surface 101 of the substrate 100 is formed as a polished surface. In addition, the substrate 100 is provided with a recess portion 102, which is formed by etching from a side of a back surface 103 of the substrate 100 to have a box shape.

Thereby, the substrate 100 includes a deformable thin plate elastic portion 104 formed between the surface 101 and a bottom surface 102a of the box-shaped recess portion 102. Hence, the substrate 100 is configured to have the box shape provided with the thin plate elastic portion 104 as an upper plate portion and both side plate portions 105. It is noted that a surface of the thin plate elastic portion 104 is configured as a part of the surface 101 of the substrate 100.

The strain-generating element 110, formed to be cross-shaped, is provided on the bottom surface 102a in the recess portion 102 of the substrate 100. The strain-generating element 110, which includes a piezoelectric element in the same manner as the strain-generating element 20, is configured with an electrode 111, piezoelectric substance 112, and electrode 113 that have the same cross shape.

The electrode 111 is formed as a cross-shaped electrode material film on the bottom surface 102a in the recess portion 102. The piezoelectric substance 112 is formed as a cross-shaped piezoelectric material film on the electrode 111. Further, the electrode 113 is formed as a cross-shaped electrode material film on the piezoelectric substance 112 so as to face the electrode 111 via the piezoelectric substance 112.

In the strain-generating element 110 configured as above, when a control voltage is applied to the piezoelectric substance 112 from the control circuit 30 via both of the electrodes 111 and 113, the piezoelectric substance 112 is distorted to elongate or contract in cross directions thereof along the surface of the thin plate elastic portion 104 depending on the applied control voltage.

When the piezoelectric substance 112 is distorted to elongate in the cross directions thereof, the thin plate elastic portion 104 of the substrate 100 is bent to bulge toward a side of the recess portion 102. Meanwhile, when the piezoelectric substance 112 is distorted to contract in the cross directions thereof, the thin plate elastic portion 104 of the substrate 100 is bent to bulge toward an opposite side of the recess portion 102.

The control circuit 30, described in the first embodiment, applies a control voltage between both of the electrodes 111 and 113 of the strain-generating element 110 in the sixth embodiment, instead of applying the control voltage between both of the electrodes 21 and 23. It means that a reflected position and reflected direction of the image light incident onto the thin plate elastic portion 104 are controlled to vary depending on a level of the deformation of the thin plate elastic portion 104 in response to the control voltage from the control circuit 30.

The U-shaped supporting member 80, described in the fifth embodiment, is configured with the upper plate portion 82 and both of the side plate portions 81, which are arranged to respectively face the upper plate portion 104 and both of the side plate portions 105 of the substrate 100. Further, the U-shaped supporting member 80 is provided on the installation surface L so as to cover the light reflecting device Ua. Here, when the thin plate elastic portion 104 of the substrate 100 is not deformed, the convex lens 90, described in the fifth embodiment, is arranged such that the image side focal point f is located in a center of a mirror surface of the thin plate elastic portion 104. The other constitutes are the same as the fifth embodiment.

In the wave front curvature modulator thus configured in the sixth embodiment, when the collimated light is emitted from the optical system toward the convex lens 90 along the optical axis of the optical system in the same manner as the fifth embodiment, the collimated light is converged by the convex lens 90 and incident onto the center of the mirror surface of the thin plate elastic portion 104.

Meanwhile, when the thin plate elastic portion 104 of the substrate 100 is not deformed, the collimated light is converged in the center of the mirror surface of the thin plate elastic portion 104. Accordingly, the light converged in this manner is reflected on the center of the mirror surface of the thin plate elastic portion 104, and then transmitted through the convex lens 90 to be collimated. Thereafter, the collimated light advances in an opposite direction of a direction in which the collimated light emitted from the optical system advances.

In such a state, when the thin plate elastic portion 104 of the substrate 100 is bent to bulge toward the side of the recess portion 102 as described above, the center of the mirror surface of the thin plate elastic portion 104 is shifted below the focal point of the convex lens 90 in FIG. 8.

Therefore, the incident light is converged by the convex lens 90 to be focused in the image side focal point f above the center of the mirror surface of the thin plate elastic portion 104. Thereafter, the light is incident onto the center of the mirror surface as diverging light, and reflected thereon.

Accordingly, the light reflected in this manner is incident onto the convex lens 90 again, and then advances toward the aforementioned optical system after being converged by the convex lens 90. In other words, the reflected on the center of the mirror surface of the thin plate elastic portion 104 advances toward the aforementioned optical system as the converged light having not a plane wave front but a wave front curvature.

Since the strain-generating element 110 is formed to be cross-shaped as described above, the thin plate elastic portion 104 is deformed, symmetrically with respect to the center of the mirror surface, at portions thereof corresponding to the cross directions of the strain-generating element 1 0. Therefore, the light, which is incident onto the center of the mirror surface after being focused in the image side focal point f, is reflected on the center of the mirror surface as light having a substantially circle cross-section due to the aforementioned symmetric deformation of the thin plate elastic portion 104. Hence, the light advances toward the optical system as converged light having a wave front curvature and substantially circle cross-section.

Meanwhile, when the thin plate elastic portion 104 is bent to bulge toward the opposite side of the recess portion 102, the center of the mirror surface of the thin plate elastic portion 104 is shifted above the focal point of the convex lens 90 in FIG. 8.

Therefore, the light converged by the convex lens 90 is incident onto the center of the mirror surface located above the focal point f, and then reflected thereon.

Hence, the light reflected in this manner advances toward the aforementioned optical system as diverging light due to an optical effect of the convex lens 90. In other words, the light, reflected on the center of the mirror surface of the thin plate elastic portion 104, advances toward the aforementioned optical system as diverging light having not a plane wave front but a wave front curvature.

Since the thin plate elastic portion 104 is deformed, symmetrically with respect to the center of the mirror surface, at portions thereof corresponding to the cross directions of the strain-generating element 110 as described above, the light, which is incident onto the center of the mirror surface before reaching the image side focal point f, is reflected on the center of the mirror surface as light having a substantially circle cross-section. Accordingly, the light advances toward the optical system as diverging light having a wave front curvature and the substantially circle cross-section.

As described above, since the strain-generating element 110 is formed to be cross-shaped, the thin plate elastic portion 104 is deformed symmetrically with respect to a portion thereof corresponding to a center of the strain-generating element 110. Thereby, the light, which advances toward the substrate 100 after being converged by the convex lens 90, is reflected on the center of the mirror surface of the thin plate elastic portion 104 as light having the substantially circle cross-section due to the aforementioned symmetric deformation of the thin plate elastic portion 104 toward the side or opposite side of the recess portion 102.

Therefore, the wave front curvature of the light that has been reflected on the center of the mirror surface of the thin plate elastic portion 104 and emitted from the convex lens 90 is modulated to maintain a preferred symmetric property thereof in response to the symmetric deformation of the thin plate elastic portion 104. In addition to the aforementioned effect, the same effects as the fifth embodiment can also be brought in the sixth embodiment.

### Seventh Embodiment

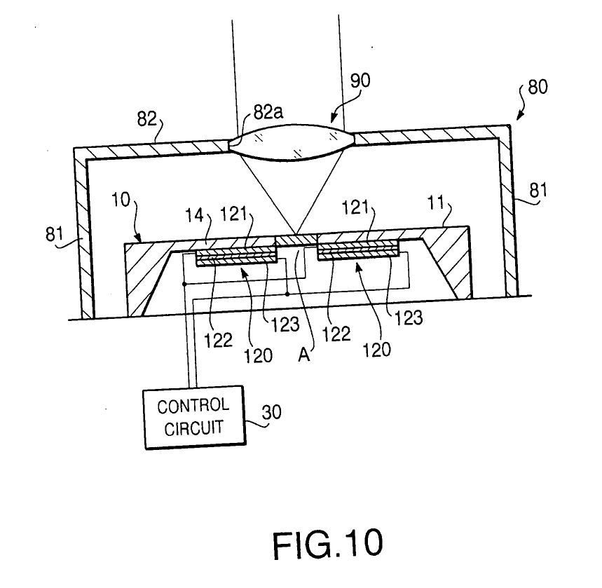

FIG. 10 shows a wave front modulator in a seventh embodiment according to aspects of the present invention. In the seventh embodiment, there is employed a configuration in which both strain-generating elements 120 are provided as substitute for the strain-generating element 20 (see FIG. 6) in the fifth embodiment.

The strain-generating elements 120 are configured with the strain-generating element 20 from which a center portion in the longitudinal direction of thereof is removed. Both of the strain-generating elements 120 are driven by an in-phase driving voltage so as to elongate or contract in the same direction as the strain-generating element 20.

Each of the strain-generating elements 120 is configured with an electrode 121, piezoelectric substance 122, and electrode 123 that correspond to the electrode 21, piezoelectric substance 22, and electrode 23 of the strain-generating element 20, respectively. It is noted that the center of the mirror surface is located in a position on the thin plate elastic portion 14 that corresponds to a spatial domain A formed between both ends of the strain-generating elements 120 that face one another.

In addition, the control circuit 30, described in the fifth embodiment, is configured to apply a voltage between both of the electrodes 121 and 123 for each of the strain-generating elements 120. The other constitutions are the same as the fifth embodiment.

In the wave front curvature modulator configured as above in the seventh embodiment, the stain-generating elements 120 are configured with the strain-generating element 20 from which the center portion in the longitudinal direction thereof is removed. Namely, the strain-generating elements 120 do not exist in the spatial domain A.

Therefore, when the strain-generating elements 120 are driven in an in-phase manner by the control voltage from the control circuit 30 so as to elongate or contract in the same direction as the strain-generating element 20, the thin plate portion 14 is deformed at the portions thereof corresponding to the strain-generating elements 120, yet is hard to be deformed in the longitudinal direction thereof at the portion thereof above the spatial domain A in FIG. 10. Accordingly, the portion of the thin plate elastic portion 14 above the spatial domain A in FIG. 10 is shifted up and down to maintain its flatness.

For this reason, even though the converged light emitted from the convex lens 90 is incident onto the center of the mirror surface of the thin plate elastic portion 14, regardless of the deformation of thin plate elastic portion 14 to bulge toward the side or opposite side of the recess portion 12, the converged light is reflected on the center of the mirror surface of the thin plate elastic portion 14, namely, the portion of the thin plate elastic portion 14 above the spatial domain A in FIG. 10 as light having a substantially circle cross-section.

Consequently, the wave front curvature of the light, which has been reflected on the center of the mirror surface of the thin plate elastic portion 14 and emitted from the convex lens 90, can be modulated to maintain a preferred symmetric property thereof, since the portion of the thin plate elastic portion 14 above the spatial domain A in FIG. 10 is hard to be deformed. In addition to the aforementioned effect, the same effects as the fifth embodiment can be brought in the seventh embodiment. It is noted that the incident light can be reflected with the wave front curvature being changed by controlling a deformation level of a portion around the center of the mirror surface of the thin plate elastic portion 14 without the convex lens 90 provided in the fifth to seventh embodiments. For example, the collimated incident light is reflected as converged light in the case where the thin plate elastic portion 14 is bent to bulge toward the side of the recess portion 12. Meanwhile, the collimated incident light is reflected as diverging light in the case where the thin plate elastic portion 14 is bent to bulge toward the opposite side of the recess portion 12.

### Eighth Embodiment

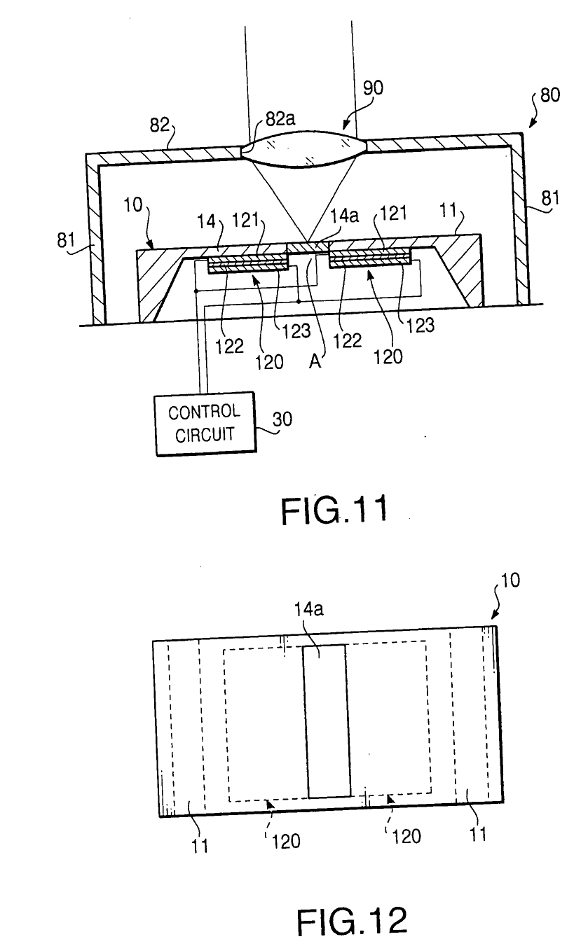

FIGS. 11 and 12 show a wave front curvature modulator in an eighth embodiment according to aspects of the present invention. In the eighth embodiment, the portion of the thin plate elastic portion 14 above the spatial domain A in FIG. 10 of the seventh embodiment is formed as a high stiffness portion 14a.

Specifically, the high stiffness portion 14a is formed by performing a hardening process such as laser quenching and shot peening for the portion of the thin plate elastic portion 14 above the spatial domain A in FIG. 11. The other constitutions are the same as the seventh embodiment.

In the wave front curvature modulator thus configured in the eighth embodiment, as described above, the portion of the thin plate elastic portion 14 above the spatial domain A in FIG. 11 is formed as the high stiffness portion 14a. Furthermore, the strain-generating elements 120 do not exist in the spatial domain A beneath the high stiffness portion 14a in the same manner as the seventh embodiment.

Accordingly, the high stiffness portion 14a is harder to deform than the corresponding portion above the spatial domain A in FIG. 10 of the seventh embodiment when the thin plate elastic portion 14 is deformed in response to the elongation or contraction of the strain-generating elements 120.

For this reason, even though the converged light emitted from the convex lens 90 is incident onto the center of the mirror surface of the thin plate elastic portion 14, regardless of the deformation of thin plate elastic portion 14 to bulge toward the side or opposite side of the recess portion 12, the converged light is reflected on the center of the mirror surface of the thin plate elastic portion 14, namely, the high stiffness portion of the thin plate elastic portion 14 above the spatial domain A in FIG. 11 as light having a cross-section of a further preferred circle shape.

Consequently, the wave front curvature of the light, which has been reflected on the center of the mirror surface of the thin plate elastic portion 14 and emitted from the convex lens 90, can be modulated to maintain a further preferred symmetric property thereof. In addition to the aforementioned effect, the same effects as the seventh embodiment can be brought in the eighth embodiment.

It is noted that, in the eighth embodiment, when the substrate 10 is formed from not a silicon substrate but a stainless substrate, the high stiffness portion 14a can be formed by implanting nitrogen into the corresponding portion of the thin plate elastic portion 14 above the spatial domain A in FIG. 11 to harden the corresponding portion.

The same effects as the eighth embodiment can be achieved by the above technique. It is noted that preferred electrical isolation between the strain-generating elements 120 and the stainless substrate can be maintained with the strain-generating elements 120 being provided on the thin plate elastic portion 14 of the stainless substrate via an insulating plate. In addition, since there is generated a certain level of roughness on the back surface of the thin plate elastic portion 14 due to characteristics of the stainless substrate, the insulating plate can preferably be adhered to the back surface of the thin plate elastic portion 14 of the stainless substrate.

### Ninth Embodiment

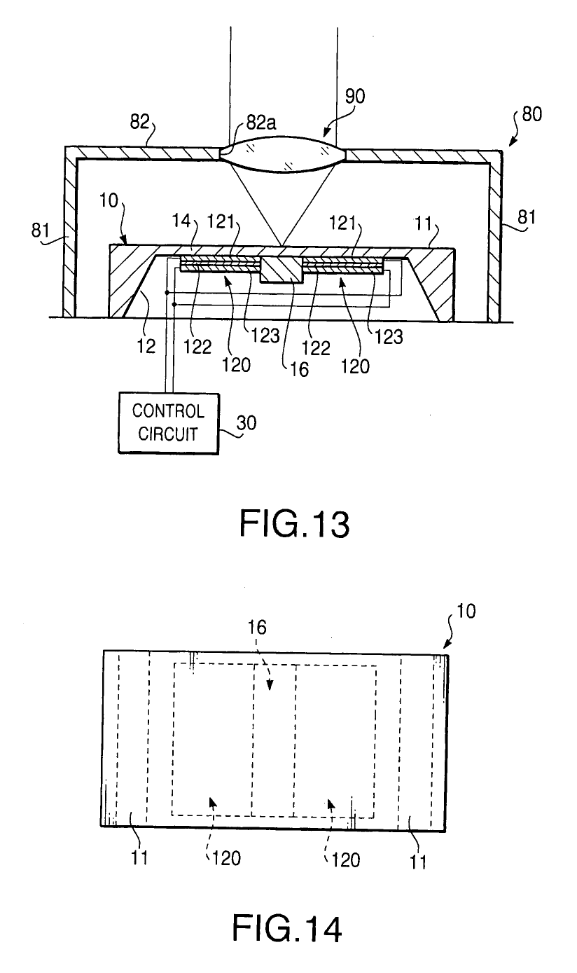

FIGS. 13 and 14 show a wave front curvature modulator in a ninth embodiment according to aspects of the present invention. In the ninth embodiment, a high stiffness member 16 is firmly attached to the back surface of the thin plate elastic portion 14 in a position corresponding to the spatial domain A in the seventh embodiment. The other constitutions are the same as the seventh embodiment.

In the wave front curvature modulator configured as above in the ninth embodiment, the high stiffness member 16 is firmly attached to the back surface of the thin plate elastic portion 14 in the spatial domain A between both of the stain-generating elements 120. Therefore, even when the thin plate elastic portion 14 is deformed in response to the elongation and contraction of the strain-generating elements 120, the portion of the thin plate elastic portion 14 above the high stiffness member 16 in FIG. 13 is hard to be deformed.

For this reason, even though the converged light emitted from the convex lens 90 is incident onto the center of the mirror surface of the thin plate elastic portion 14, regardless of the deformation of thin plate elastic portion 14 to bulge toward the side or opposite side of the recess portion 12, the converged light is reflected on the center of the mirror surface of the thin plate elastic portion 14, namely, the portion of the thin plate elastic portion 14 above the high stiffness member 16 in FIG. 13 as light having a cross-section of a preferred circle shape.

Consequently, the wave front curvature of the light, which has been reflected on the center of the mirror surface of the thin plate elastic portion 14 and emitted from the convex lens 90, can be modulated to maintain a further preferred symmetric property thereof. In addition to the aforementioned effect, the same effects as the seventh embodiment can be brought in the ninth embodiment.

It is noted that, in the ninth embodiment, in the case where the substrate 10 is formed from a silicon substrate, the high stiffness member 16 can be formed integrally with the substrate 10 by keeping a portion of the silicon substrate corresponding to the high stiffness member 16 from being etched when forming the recess portion 12 by etching the silicon substrate. In such a case, since the high stiffness member 16 is not required to be separately prepared, a manufacturing process for the wave front curvature modulator in the ninth embodiment can be simplified, accompanied by an improved process yield and a reduced cost for the wave front curvature modulator.

### Tenth Embodiment

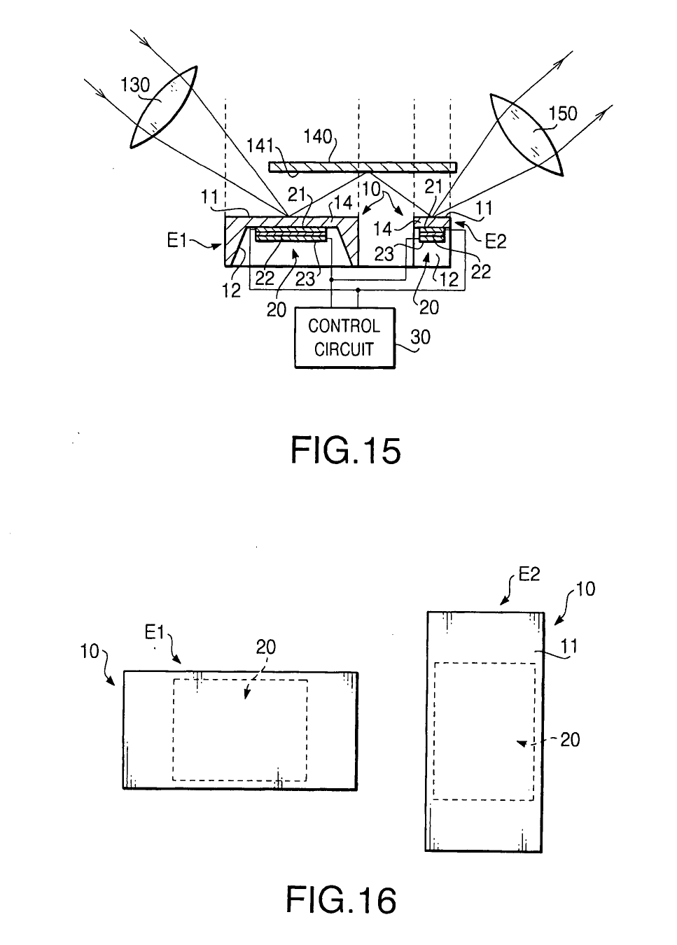

FIG. 15 shows another example of a wave front curvature modulator in a tenth embodiment according to aspects of the present invention. The wave front curvature modulator is configured with light reflecting elements E1 and E2, a reflecting plate 140, convex lenses 130 and 150, and the control circuit 30 described in the first embodiment.

Each of the light reflecting elements E1 and E2 has the same configuration as the light reflecting device in the first embodiment. The light reflecting element E1 is located at a right side of the light reflecting element E2 as shown in FIGS. 15 and 16. The light reflecting element E1 is provided such that a longitudinal direction thereof is arranged along a horizontal direction in FIG. 15. Meanwhile, the light reflecting element E2 is provided such that a longitudinal direction thereof is arranged along a direction perpendicular to FIG. 15, namely, along a depth direction of FIG. 15 (see FIG. 16).

In addition, the light reflecting elements E1 and E2 are located such that the surfaces 11 of the substrates 10 thereof are on the same plane. Further, a center of the substrate 10 in the light reflecting element E1 in the longitudinal direction thereof and a center of the substrate 10 in the light reflecting element E2 in the longitudinal direction thereof are located on the same line along the longitudinal direction of the light reflecting element E1.

In each of the light reflecting elements E1 and E2 arranged as above, light incident thereto is reflected on the center of the mirror surface of the thin plate elastic portion 14.

The convex lens 130 is, as shown in FIG. 15, arranged in a tilted state at the upper left of the light reflecting element E1. The convex lens 130 converges collimated light emitted from an optical system (not shown), and causes the converged light to be incident onto the center of the mirror surface of the thin plate elastic portion 14 in the light reflecting element E1. It is noted that, when the strain-generating element 20 of the light reflecting element E1 is not distorted, an image side focal point of the convex lens 130 is located on the center of the mirror surface of the thin plate elastic portion 14 in the light reflecting element E1.

As shown in FIG. 15, the reflecting plate 140 is supported above both of the light reflecting elements E1 and E2 so as to be parallel to the thin plate elastic portion 14 of each of the light reflecting elements E1 and E2. Further, the reflecting plate 140 is arranged such that a reflecting surface 141 thereof faces the surface 11 of each of the substrates 10.

Thereby, the light reflected on the center of the mirror surface of the thin plate elastic portion 14 in the light reflecting element E1 is incident onto and reflected by the reflecting surface 141 of the reflecting plate 140, so as to be incident onto the center of the mirror surface of the thin plate elastic portion 14 in the light reflecting element E2.

The convex lens 150 is, as shown in FIG. 15, arranged in a tilted state at the upper right of the light reflecting element E2. The light reflected on the center of the mirror surface of the thin plate elastic portion 14 in the light reflecting element E2 is collimated and emitted by the convex lens 150. It is noted that, when the strain-generating element 20 of the light reflecting element E2 is not distorted, an object side focal point of the convex lens 150 is adopted to be located on the center of the mirror surface of the thin plate elastic portion 14 in the light reflecting element E2.

The control circuit 30 is configured to apply a control voltage between the electrodes 21 and 23 of each of the strain-generating element 20. The other constitutions are the same as the first embodiment.

In the wave front curvature modulator configured as above in the tenth embodiment, when the collimated light emitted from the aforementioned optical system is converged by the convex lens 130 and incident onto the center of the mirror surface of the thin plate elastic portion 14 in the light reflecting element E1, the incident light is reflected on the center of the mirror surface of the thin plate elastic portion 14 in the light reflecting element E1 so as to be directed toward the reflecting plate 140 as indicated by arrows in FIG. 15.

Then, when the reflected light is reflected by the reflecting surface 141 of the reflecting plate 140 and incident onto the center of the mirror surface of the thin plate elastic portion 14 in the light reflecting element E2, the incident light is reflected on the center of the mirror surface of the thin plate elastic portion 14 in the light reflecting element E2. Thereafter, the reflected light is collimated and emitted by the convex lens 150.

In such a state, when the thin plate elastic portion 14 in each of the light reflecting elements E1 and E2 is bent to bulge toward the side of the recess portion 12 in the same manner as described in the first embodiment, the converged light emitted from the convex lens 130 is focused in the image side focal point located above the center of the mirror surface of the thin plate elastic portion 14 in the light reflecting element E1. Thereafter, the light is incident onto the center of the mirror surface of the thin plate elastic portion 14 in the light reflecting element E1.

Further, the light reflected by the reflecting plate 140 is incident onto and reflected by the center of the mirror surface, located under the object side focal point of the convex lens 150, of the thin plate elastic portion 14 in the light reflecting element E2. Then, the reflected light is directed toward the convex lens 150.

Meanwhile, when the thin plate elastic portion 14 of each of the light reflecting elements E1 and E2 is bent to bulge toward the opposite side of the recess portion 12 in the same manner as described in the first embodiment, the converged light emitted from the convex lens 130 is incident onto the center of the mirror surface, located above the image side focal point of the convex lens 130, of the thin plate elastic portion 14 in the light reflecting element E1.

Then, the light reflected by the reflecting plate 140 is incident onto and reflected by the center of the mirror surface, located above the object side focal point of the convex lens 150, of the thin plate elastic portion 14 in the light reflecting element E2. Thereafter, the reflected light is directed toward the convex lens 150.

The substrate 10 of the light reflecting element E1 is arranged to extend in the horizontal direction in FIG. 15. Meanwhile, the substrate 10 of the light reflecting element E2 is arranged to extend in the direction perpendicular to FIG. 15, namely, in the depth direction of FIG. 15. Therefore, the light converged by the convex lens 130 is incident onto the center of the mirror surface of the thin plate elastic portion 14 such that a horizontal component of a light advancing direction is along the longitudinal direction of the substrate 10 of the light reflecting element E1. Further, the light reflected by the reflecting plate 140 is incident onto the center of the mirror surface of the thin plate elastic portion 14 such that the horizontal component of the light advancing direction is along a width direction (a direction perpendicular to the longitudinal direction in a horizontal plane) of the substrate 10 of the light reflecting element E2.

Additionally, in each of the light reflecting elements E1 and E2, the strain-generating element 20 is provided on the back surface of the thin plate elastic portion 14 so as to extend in the longitudinal direction of the thin plate elastic portion 14. Furthermore, the strain-generating element 20 is distorted to elongate or contract in the longitudinal direction thereof, and is hard to be distorted in the width direction thereof.

Accordingly, a cross-sectional shape of the light incident onto the substrate 10 of the light reflecting element E1 after being converged by the convex lens 130 is distorted in a horizontal direction in FIG. 16 on the center of the mirror surface of the thin plate elastic portion 14 in the light reflecting element E1. Meanwhile, a cross-sectional shape of the light incident onto the substrate 10 of the light reflecting element E2 after being reflected by the reflecting plate 140 is distorted in an up-and-down direction in FIG. 16 on the center of the mirror surface of the thin plate elastic portion 14 in the light reflecting element E2.

Hence, the cross-sectional shape of the light in an optical path from the convex lens 130 to the convex lens 150 is distorted in the same manner in both of the horizontal direction and up-and-down direction in FIG. 16. Thereby, the light reflected by the light reflecting element E2 is directed toward the convex lens 150 as light of a substantially circle cross-sectional shape.

Consequently, a wave front curvature of the light directed from the convex lens 130 to the convex lens 150 can be modulated to maintain a preferred symmetric property thereof in response to the bending deformation of the thin plate elastic portion 104.

In addition, when the wave front curvature modulator is configured such that the light is incident onto the convex lens 150 and emitted from the convex lens 130, there can be expected the same effects as the aforementioned configuration in which the light is incident onto the convex lens 130 and emitted from the convex lens 150 as shown in FIG. 15.

### Eleventh Embodiment

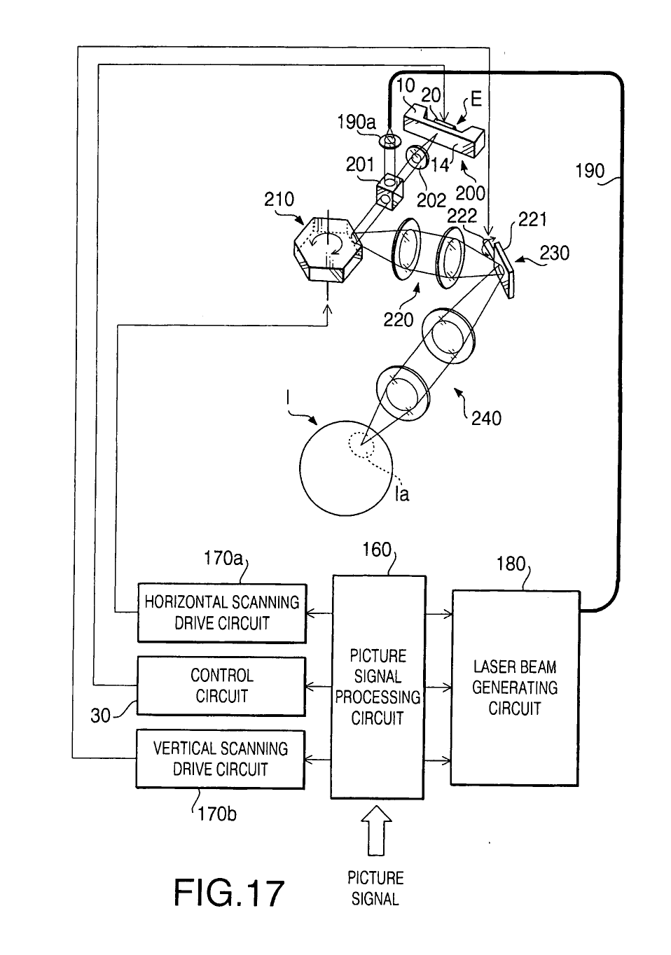

FIG. 17 shows an example of a retina scanning type display device in an eleventh embodiment to which the light reflecting device described in the first embodiment is applied.

The retina scanning type display device shown in FIG. 17 is for a left eye of a user. The retina scanning type display device may be used independently or in combination with that for a right eye. Since the retina scanning type display devices for the left and right eyes have much the same configuration, there will be explained hereinafter the retina scanning type display device for the left eye.

The display device is provided with a picture signal processing circuit 160. Based on a picture signal from an external circuit, the picture signal processing circuit 160 generates a horizontal synchronizing signal, vertical synchronizing signal, blue driving signal, green driving signal, red driving signal, and depth signal representing a depth of a picture.

The display device includes a horizontal scanning drive circuit 170a and vertical scanning drive circuit 170b. The horizontal scanning drive circuit 170a causes a horizontal scanning mechanism 210 to horizontally scan light (below-mentioned laser light) based on the horizontal synchronizing signal from the picture signal processing circuit 160. The vertical scanning drive circuit 170b causes a vertical scanning mechanism 230 to vertically scan the light (below-mentioned laser light).

In addition, the display device is provided with a laser beam generating circuit 180. The laser beam generating circuit 180 generates blue laser light, green laser light, and red laser light based on the blue driving signal, green driving signal, and red driving signal from the picture signal processing circuit 160, respectively. Further, the laser beam generating circuit 180 modulates intensities of the blue laser light, green laser light, and red laser light based on the blue driving signal, green driving signal, and red driving signal, respectively, and unites the three intensity-modulated laser light to generate an image laser beam.

In addition, the display device includes an optical fiber 190, collimating lens 190a, and wave front curvature modulator 200. The optical fiber 190 introduces the image laser beam emitted from the laser beam generating circuit 180 to the collimating lens 1 90a. The collimating lens 190a collimates the image laser beam emitted from the optical fiber 190, and emits the collimated the image laser beam toward the wave front curvature modulator 200.

The wave front curvature modulator 200 is configured with the control circuit 30 and light reflecting element (hereinafter, referred to as a light reflecting element E) that are included in the light reflecting device as described in the first embodiment, beam-splitter 201, and convex lens 202.

The light reflecting element E is arranged such that the thin plate elastic portion 14 faces the beam-splitter via the convex lens 202.

The beam-splitter 201 has a function of dividing the collimated light emitted from the collimating lens 190a into two light beams. One of the light beams is reflected by the beam-splitter 201 and directed toward the convex lens 202. The other is transmitted through the beam-splitter 201 and directed toward the horizontal scanning mechanism 210.

The convex lens 202 converges the collimated light emitted from the beam-splitter 201 and causes the converged light to be incident onto the center of the mirror surface of the thin plate elastic portion 14 in the light reflecting element E. Further, the convex lens 202 causes the light reflected by the center of the mirror surface of the thin plate elastic portion 14 in the light reflecting element E to deflect so as to be directed toward the beam-splitter 201.

In the eleventh embodiment, the convex lens 202 is arranged such that a focal point thereof is located in the center of the mirror surface of the thin plate elastic portion 14 when the thin plate elastic portion 14 of the substrate 10 in the light reflecting element E is not bent.

Accordingly, when the thin plate elastic portion 14 is bent to bulge toward the side or opposite side of the recess portion 12, the light reflected by the center of the mirror surface of the thin plate elastic portion 14 is deflected as converged light or diverging light toward the horizontal scanning mechanism 210 via the beam-splitter 201. It means that the light collimated by the collimated lens 190a (i.e., the image laser beam emitted by the laser beam generating circuit 180) is emitted toward the horizontal scanning mechanism 210 with the wave front curvature being modulated by the wave front curvature modulator.

The control circuit 30 generates a control voltage depending on a depth level based on the depth signal from the picture signal processing circuit 160, and applies the generated control voltage to the strain-generating element 20 of the light reflecting element E.

The horizontal scanning mechanism 210, which includes a polygon mirror, is driven by the horizontal scanning drive circuit 170a. Further, the horizontal scanning mechanism 210 horizontally scans the light emitted from the beam-splitter 201 such that the scanned light is directed toward the vertical scanning mechanism 230 via a relay optical system 220.

The vertical scanning mechanism 230, which is driven by the vertical scanning drive circuit 170b, vertically scans the horizontally-scanned light emitted from the relay optical system 220, and causes the vertically-scanned light to be incident onto a pupil Ia of a left eye I of a user as two-dimensionally scanned light via a relay optical system 240. Thereby, the two-dimensionally scanned light forms a two-dimensional image on a retina of the left eye I.

As described above, the image laser beam emitted by the laser beam generating circuit 180 is incident onto the left eye I via the horizontal scanning mechanism 210, relay optical system 220, vertical scanning mechanism 230, and relay optical system 240 with the wave front curvature thereof being modulated by the wave front modulator 200. Accordingly, the image on the retina of the left eye is formed in accordance with a focus location depending on the modulated wave front curvature of the image laser beam.

In the retina scanning type display device thus configured in the eleventh embodiment, the light reflecting element E of the light reflecting device is configured with the substrate 10 and the strain-generating element 20 as described in the first embodiment, so as to have a small size. Thereby, the wave front curvature modulator 200 including the convex lens 202 is also configured to have a small size. Consequently, the display device can be downsized.

Hereinabove, the embodiments according to aspects of the present invention have been described. The present invention can be practiced by employing conventional materials, methodology and equipment. Accordingly, the details of such materials, equipment and methodology are not set forth herein in detail. In the previous descriptions, numerous specific details are set forth, such as specific materials, structures, chemicals, processes, etc., in order to provide a thorough understanding of the present invention. However, it should be recognized that the present invention can be practiced without resorting to the details specifically set forth. In other instances, well known processing structures have not been described in detail, in order not to unnecessarily obscure the present invention.

Only exemplary embodiments of the present invention and but a few examples of its versatility are shown and described in the present disclosure. It is to be understood that the present invention is capable of use in various other combinations and environments and is capable of changes or modifications within the scope of the inventive concept as expressed herein.

For example, the following modifications may be possible. (1) The strain-generating element 20, 50, or 120 is not limited to the piezoelectric element, and, for example, may be an electrostrictive element or magnetostrictive element. (2) The substrate 70 described in the fourth embodiment is made of synthetic resin material. Further, the thin plate elastic portion 71 of the substrate 70 is preferred to have a surface formed in substantially the same manner as a polished surface. (3) The surface (polished surface) of the substrate 10 may be configured as a mirror surface coated with a reflective thin film. (4) The substrate 10 may generally be an appropriately shaped base body. Further, the recess portion 12 provided with the thin plate elastic portion and side plate portions may be formed by etching the base body. Further, the base body is configured with the thin plate portion and side plate portions to form the recess portion. (5) The display device, to which the present invention is to be applied to, is not limited to the retina scanning type display device. It may be a light scanning type display device configured to display an image thereon by scanning light generally modulated by a picture signal in the two-dimensional directions. When the wave front curvature modulator 200 is applied to the light scanning type display device, the light scanning type display device can be downsized. (6) Since an area on the substrate 10 on which the mirror surface is to be formed may just include even an area by which the light is likely to be reflected, the mirror surface may be formed only on the area on which the light is likely to be reflected. (7) In the sixth embodiment, the shape of the strain-generating element 110 is not limited to the cross shape. The strain-generating element 110 may be configured on the bottom surface 102a of the box-shaped recess portion 102 with a plurality of strain-generating portions radially and symmetrically extending with respect to the center of the mirror surface.

What is claimed is:

1. A light reflecting device, comprising:
an elastic plate portion configured to be elastically deformable, the elastic plate portion having a first surface and a second surface that is an opposite surface of the first surface;
a mirror formed on the first surface of the elastic plate portion;
at least one supporting portion configured to support the elastic plate portion to form a recessed area at a side of the second surface; and
at least one strain-generating element provided on the second surface in the recessed area to bend the elastic plate portion in response to deformation thereof.

2. The light reflecting device according to claim 1, further comprising a supporting member attached to the at least one supporting portion from the second surface side of the elastic plate portion so as to face the at least one strain-generating element.

3. The light reflecting device according to claim 1,
wherein the mirror is formed as a polished area on the first surface of the elastic plate portion.

4. The light reflecting device according to claim 3,
wherein the mirror is formed as a reflective film coated on the polished area on the first surface of the elastic plate portion.

5. The light reflecting device according to claim 1,
wherein the at least one supporting portion is configured to be elastic.

6. The light reflecting device according to claim 1,
wherein the elastic plate portion and the at least one supporting portion are integrally formed.

7. The light reflecting device according to claim 6,
wherein the elastic plate portion and the at least one supporting portion are integrally formed by etching a silicon substrate.

8. The light reflecting device according to claim 1,
wherein the elastic plate portion and the at least one supporting portion are formed from metal material.

9. The light reflecting device according to claim 1,
wherein the elastic plate portion is configured to extend along a predetermined direction to be defined as a longitudinal direction thereof.

10. The light reflecting device according to claim 9,
wherein the at least one strain-generating element is arranged to extend along the longitudinal direction of the elastic plate portion.

11. The light reflecting device according to claim 1,
wherein the at least one strain-generating element is configured with a plurality of strain-generating portions radially and symmetrically extending with respect to a center of the elastic plate portion on the second surface of the elastic plate portion.

12. The light reflecting device according to claim 11,
wherein the at least one strain-generating element is configured to be cross-shaped.

13. The light reflecting device according to claim 9,
wherein the at least one strain-generating element includes a couple of strain-generating elements, which are arranged with a predetermined space therebetween along the longitudinal direction of the elastic plate portion so as to respectively extend along the longitudinal direction of the elastic plate portion.

14. The light reflecting device according to claim 13,
wherein the couple of strain-generating elements are driven in an in-phase manner.

15. The light reflecting device according to claim 13,
wherein a part of the elastic plate portion corresponding to the predetermined space between the couple of strain-generating elements is formed from material with a higher stiffness than the other part of the elastic plate portion.

16. The light reflecting device according to claim 13,
wherein there is provided on a partial area of the second surface of the elastic plate portion that corresponds to the predetermined space between the couple of strain-generating elements, a member with a higher stiffness than the other partial area of the second surface.

17. The light reflecting device according to claim 1,
wherein the at least one strain-generating element includes a piezoelectric element.

18. The light reflecting device according to claim 1,
wherein the at least one strain-generating element includes an electrostrictive element.

19. A light reflecting apparatus, comprising;
a first light reflecting device and second light reflecting device, each of which comprises:
an elastic plate portion configured to be elastically deformable and extend along a predetermined direction to be defined as a longitudinal direction thereof, the elastic plate portion having a first surface and a second surface that is an opposite surface of the first surface;
a mirror formed on the first surface of the elastic plate portion;
at least one supporting portion configured to support the elastic plate portion to form a recessed area on the second surface at a side of the second surface; and
at least one strain-generating element provided on the second surface in the recessed area to bend the elastic plate portion in response to deformation thereof, the at least one strain-generating element being arranged to extend along the longitudinal direction of the elastic plate portion;
an optical system configured to converge incident light and make the converged light incident onto the mirror of the first light reflecting device; and
a reflecting plate configured to reflect, toward the mirror of the second light reflecting device, the light reflected by the mirror of the first light reflecting device,
wherein the first and second light reflecting devices are arranged such that the longitudinal directions of the elastic plate portions thereof are perpendicular to one another and such that the mirrors thereof are parallel to one another without the mirrors overlapping one another in a direction perpendicular to the mirrors.

20. A wave front curvature modulator, comprising:
at least one light reflecting device, each of which comprises:
an elastic plate portion configured to be elastically deformable, the elastic plate portion having a first surface and a second surface that is an opposite surface of the first surface;
a mirror formed on the first surface of the elastic plate portion;
at least one supporting portion configured to support the elastic plate portion to form a recessed area at a side of the second surface; and
at least one strain-generating element provided on the second surface in the recessed area to bend the elastic plate portion in response to deformation thereof; and
a control unit configured to control a strain-generated direction in which the at least one strain-generating element is deformed,
wherein the at least one light reflecting device generates reflected light with a wave front curvature thereof being modulated by deforming the elastic plate portion in response to the deformation of the at least one strain-generating element in the strain-generated direction controlled by the control unit.

21. The wave front curvature modulator according to claim 20, further comprising an optical system configured to converge incident light in a region near the mirror,
wherein the at least one light reflecting device reflects the converged light toward the optical system in a position on the mirror that is displaced by deforming the elastic plate portion in response to the deformation of the at least one strain-generating element in the strain-generated direction controlled by the control unit.

22. An optical scanning type display device, comprising:
a light emitting unit configured to emit image light that includes image information;
a scanning unit configured to two-dimensionally scan the image light emitted by the light emitting unit; and
a wave front curvature modulator located on an optical path of the image light between the light emitting unit and the scanning unit,
wherein the wave front curvature modulator comprises:
at least one light reflecting device that comprises:
an elastic plate portion configured to be elastically deformable, the elastic plate portion having a first surface and a second surface that is an opposite surface of the first surface;
a mirror formed on the first surface of the elastic plate portion;
at least one supporting portion configured to support the elastic plate portion to form a recessed area at a side of the second surface; and
at least one strain-generating element provided on the second surface in the recessed area to bend the elastic plate portion in response to deformation thereof; and
a control unit configured to control a strain-generated direction in which the at least one strain-generating element is deformed, and
wherein the at least one light reflecting device reflects the image light emitted by the light emitting unit to be incident to the scanning unit with the wave front curvature of the image light being modulated by deforming the elastic plate portion in response to the deformation of the at least one strain-generating element in the strain-generated direction controlled by the control unit.
